(19) United States
(12) Patent Application Publication
(10) Pub. No.: US 2014/0237190 A1
(43) Pub. Date: Aug. 21, 2014

(54) MEMORY SYSTEM AND MANAGEMENT METHOD THEROF

(71) Applicant: INDUSTRY-ACADEMIA COOPERATION GROUP OF SEJONG UNIVERSITY, Seoul (KR)

(72) Inventor: Gi Ho Park, Seoul (KR)

(21) Appl. No.: 14/192,189

(22) Filed: Feb. 27, 2014

Related U.S. Application Data
(63) Continuation of application No. PCT/KR2012/003277, filed on Apr. 27, 2012.

(30) Foreign Application Priority Data
Aug. 31, 2011 (KR) 10-2011-0087509

(51) Int. Cl. G06F 12/08; G06F 12/12

(52) U.S. Cl. CPC G06F 12/0815; G06F 12/12; G06F 2212/69
USPC 711/133; 711/154; 711/141

(57) ABSTRACT

A memory system having multiple memory layers is provided. The memory system includes an upper memory layer and an intermediate memory layer comprising a first sub-memory consisting of a nonvolatile memory and a second sub-memory consisting of a volatile memory in a parallel structure positioned below the upper memory layer, and a memory management unit that controls operations of the upper memory layer and the intermediate memory layer. The intermediate memory layer is referred by the upper memory layer, and the memory management unit stores data meeting a predetermined condition among data stored in the second sub-memory into the first sub-memory in advance when a user device comprising the memory system is operating in a normal mode.

### CROSS-REFERENCE TO RELATED APPLICATION

This application is a continuation of International Application No. PCT/KR2012/003277 filed on Apr. 27, 2012, claiming the priority based on Korean Patent Application No. 10-2011-0087509 filed on Aug. 31, 2011, the contents of all of which are incorporated herein by reference in their entirety.

### TECHNICAL FIELD

The embodiments described herein pertain generally to a memory system having a new structure and a management method thereof.

### BACKGROUND

Recently, various types of electronic devices are being used. Especially, with the development of communication technologies and computer manufacturing technologies, mobile devices such as smart phones, personal digital assistants (PDAs) and tablet PCs, as well as computer devices such as desktops and laptops, are being widely used.

In most of the cases, such various devices are required to have lower power consumption or heat emission characteristics while improving its computing performance thereof.

The embodiments described herein are intended to meet the lower power consumption or heat emission requirements through structural improvement of a memory system included in a mobile device.

FIG. 1 illustrates a hierarchical memory structure applied to a memory system according to a conventional technology.

A memory system 1 in the conventional technology includes a L1/L2 cache memory layer 10, a main memory layer 20 and a storage device 30 which provides data to a central processing unit (CPU).

The L1/L2 cache memory layer 10 and the main memory layer 20 consist of volatile memories such as SRAM and DRAM. The storage device 30 consists of nonvolatile memories such as a flash memory or a hard disk drive (HDD).

In general, a higher-priced memory with faster read/write speeds is used for a memory in an upper layer of the memory layer structure. A lower-cost memory with relatively slow read/write speeds is used for a memory in a lower layer of the memory layer structure. In the embodiment shown in FIG. 1, the L1/L2 cache memory layer 10 is the uppermost memory layer, and the storage device 30 is the lowermost memory layer.

In the conventional technology as illustrated in FIG. 1, the CPU 40 acquires data for execution of programs, etc., from the storage device 30, and stores the acquired data in the L1/L2 cache memory layer 10 as well as in the main memory layer 20.

To perform a data read or write operation, the CPU 40 requests the L1/L2 cache memory layer 10 for necessary data, that is, it requests a memory reference. If the requested data does not exist in the L1/L2 cache memory layer 10, a reference failure (cache miss) might occur.

If a reference failure (cache miss) occurs, the main memory layer 20 is requested to handle the read or write reference for the data for which the reference failure has occurred.

As described above, according to the conventional technology, if a reference failure occurs in the upper memory layer, e.g., the L1/L2 cache memory layer, the read or write reference is performed in an intermediate memory layer, which is lower than the upper memory layer. Both the upper memory layer and the intermediate memory layer consist of volatile memories.

A volatile memory and a nonvolatile memory have different characteristics in memory density, read and write speeds, power consumption, etc. In general, read and write speeds of the volatile memory are faster than those of the nonvolatile memory. Memory density of the nonvolatile memory is higher than that of the volatile memory.

Recently, as the development of nonvolatile memories is actively promoted, the access speeds of the nonvolatile memories have been increasingly improved. For example, latest nonvolatile memories such as MRAM, PRAM, and FRAM exhibit better characteristics such as memory density, power consumption about 4 to 16 times higher than those of SRAM or DRAM, and show similar read performances as that of conventional volatile memories.

Although nonvolatile memories still have lower write speeds compared to volatile memories, they can be used to improve power consumption or thermal issues of a user device by integrating into a new memory system, thereby making the best use of the advantageous characteristics of the nonvolatile memories in memory density and static power consumption.

In regard with the present disclosure, Korean Patent Application Publication No. 2011-0037092 (Title of the Invention: Hybrid Memory Structure with RAM and Flash Interface and Data Storing Method) describes a hybrid memory structure having a control interface for a RAM memory and a flash memory.

### SUMMARY

In view of the foregoing, illustrative embodiments of the present inventive concept provide a memory system having a new structure, which includes a volatile memory and a nonvolatile memory in the main memory layer, and its management method thereof.

In one illustrative embodiment of the present inventive concept, a memory system comprising multiple memory layers including an upper memory layer, a storage device memory layer, an intermediate memory layer positioned between the upper memory layer and the storage device layer, and comprising a first sub-memory consisting of a nonvolatile memory and a second sub-memory consisting of a volatile memory in a parallel structure, and a memory management unit which controls the operations of the upper memory layer, the intermediate memory layer and the storage device layer. The intermediate memory layer and the storage device layer are referred by the upper memory layer, and the memory management unit stores data meeting, a predetermined condition among data stored in the second sub-memory into the first sub-memory in advance, when a user device with the memory system is operating in a normal mode.

In another illustrative embodiment of the present inventive concept, a memory system comprising multiple memory layers, including an upper memory layer, a storage device layer, an intermediate memory layer positioned between the upper memory layer and the storage device layer. It also includes a first sub-memory consisting of a nonvolatile memory and a second sub-memory consisting of a volatile memory in a parallel structure, and a memory management unit that transfers data stored in the second sub-memory into the first sub-memory based on time elapsed since the latest reference to data stored in the upper memory layer. When the time elapsed since the latest reference exceeds a threshold, the memory management unit transfers the data to the first sub-memory.

In still another illustrative embodiment of the present inventive concept, a memory management method of a memory system which includes an upper memory layer, an intermediate memory layer and a storage device layer, and in which the intermediate memory layer is positioned between the upper memory layer and the storage device layer, and comprises a first sub-memory consisting of a nonvolatile memory and a second sub-memory consisting of a volatile memory is provided. The memory management method includes storing data that meets a predetermined condition among data stored in the second sub-memory into the first sub-memory, storing the rest data stored in the second sub-memory into the first sub-memory depending on the operation state of a user device with the memory system, and turning off the second sub-memory when storing of the rest data is completed.

In accordance with the above-described illustrative embodiments of the present inventive concept, a memory system in a new form including a volatile memory and a nonvolatile memory in a parallel structure, it is possible to store parts of data stored in the volatile memory into the nonvolatile memory in advance and selectively turn off the volatile memory depending on the operation state of the user device. Accordingly, it is also possible to minimize power consumption resulting from a refresh operation of the volatile memory, and to resolve the problem of excessive heat emission of the user device.

### BRIEF DESCRIPTION OF THE DRAWINGS

FIG. 1 illustrates a hierarchical memory structure in accordance with a conventional technology;

FIG. 2 illustrates a memory system in accordance with an illustrative embodiment of the present inventive concept;

FIG. 3 illustrates a detailed configuration of a memory management unit in accordance with an illustrative embodiment of the present inventive concept;

FIG. 4A and FIG. 4B depict a data transferring method by a memory management unit in accordance with an illustrative embodiment of the present inventive concept;

FIG. 5 depicts a data transferring method by a memory management unit in accordance with an illustrative embodiment of the present inventive concept;

FIG. 6 is a flow diagram showing a memory management method in accordance with an illustrative embodiment of the present inventive concept; and

FIG. 7 illustrates a memory system in accordance with another illustrative embodiment of the present inventive concept.

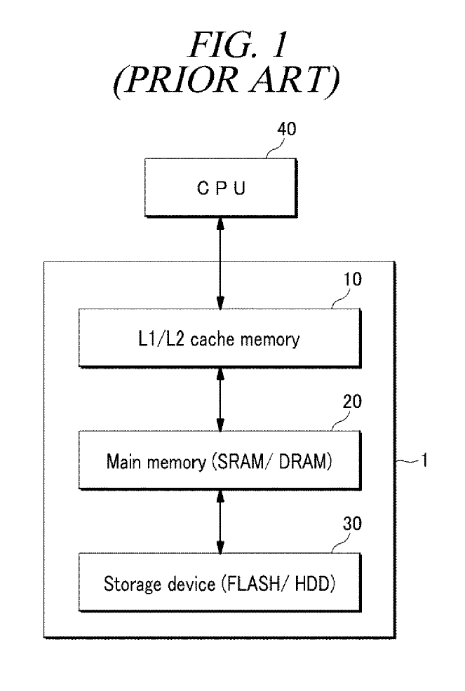

### DETAILED DESCRIPTION

Hereinafter, illustrative embodiments of the present inventive concept will be described in detail with reference to the accompanying drawings so that inventive concept may be readily implemented by those skilled in the art. However, it is to be noted that the present disclosure is not limited to the illustrative embodiments of the present inventive concept but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. In addition, the term “comprises or includes” and/or “comprising or including” used in the document means that one or more other components, steps, operations, and/or the existence or addition of elements are not excluded in addition to the described components, steps, operations and/or elements.

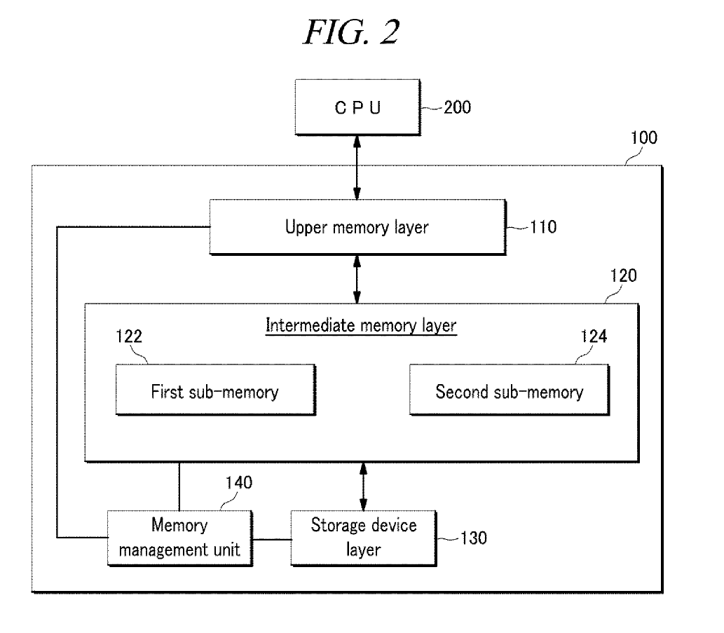

FIG. 2 illustrates a memory system in accordance with an illustrative embodiment of the present inventive concept.

A memory system 100 includes an upper memory layer 110, an intermediate memory layer 120, a storage device layer 130 and a memory management unit 140, and is connected to a CPU 200.

The central processing unit (CPU) 200 refers to data stored in the storage device layer 130, which is the lowermost layer, via the intermediate memory layer 120 to execute a certain program or for any other processing purposes. The data referred to by CPU 200 is stored in the upper memory layer 110 and the intermediate memory layer 120.

Further when the corresponding data needs to be referred again, the CPU 200 can quickly handle a read or write operation by using the data stored in the upper memory layer 110 having fast read/write speeds.

The upper memory layer 110 may include a register, a L1 or L2 cache, and a volatile memory such as SRAM or DRAM. The upper memory layer 110 receives a request for specific data for reading or writing from the CPU 200, and searches the requested data to see whether the requested data is stored in the upper memory layer 110.

If the requested data for a read or write operation does not exist in the upper memory layer 110, i.e., when a reference failure (cache miss) occurs, the upper memory layer 110 requests the data for which the reference failure has occurred to the intermediate memory layer 120, that is, a first sub-memory 122 and a second sub-memory 124 of the intermediate memory layer 120.

The intermediate memory layer 120 is a memory layer with lower read/write speed performances than those of the upper memory layer 110. However, the intermediate memory layer 120 may have higher memory density than that of the upper memory layer 110.

If the requested data exists in the first sub-memory 122 or the second sub-memory 124, the upper memory layer 110 can acquire the corresponding data from either the first sub-memory 122 or the second sub-memory 124.

The intermediate memory layer 120 includes the first sub-memory 122 and the second sub-memory 124. The first sub-memory 122 and the second sub-memory 124 may be included in a parallel structure with the intermediate memory layer 120.

In an illustrative embodiment of the present inventive concept, the first sub-memory 122 may include at least one nonvolatile memory, preferably, at least one of the memory from MRAM, PRAM and FRAM and may be used as the first sub-memory 122. In addition, the first sub-memory 122 may include different types of multiple nonvolatile memories. If different types of multiple nonvolatile memories are included, physical location of the nonvolatile memories may be determined such that the nonvolatile memory with the fastest memory access speed is placed closest to the upper memory layer 110. That is, a hierarchical structure may be used based on a memory access speed even within the first sub-memory 122.

On the contrary, the second sub-memory 124 may include at least one volatile memory, and includes SRAM or DRAM with faster read/write speed performances than those of the first sub-memory 122. The second sub-memory 124 may include different types of multiple volatile memories. In this case, physical location of the volatile memories may be determined such that the volatile memory with the fastest memory access speed is placed closest to the upper memory layer 110. That is, a hierarchical structure may be used based on a memory access speed even within the second sub-memory 124.

As described above, the first sub-memory 122 may consist of lower-cost memories with lower read/write speed performances than those of the second sub-memory 124. The nonvolatile memory is inferior in both the read/write speed performances, compared to the volatile memory. Especially, the difference in the read speeds between the nonvolatile memory and the volatile memory is not so large, while the difference in the write speeds between the nonvolatile memory and the volatile memory is significantly large. That is, the read speed of the nonvolatile memory is relatively superior to the write speed thereof. In general, since a read speed of a memory is faster than a write speed thereof, the difference between the read and write speeds of the nonvolatile memory is larger than the difference between the read and write speeds of the volatile memory.

Accordingly, if the first sub-memory 122 consists of nonvolatile memories, the difference between the read and write speeds of the first sub-memory 122 may be larger than the difference between the read and write speeds of the second sub-memory 124 consisting of volatile memories. That is, the difference in the write speed between the first sub-memory 122 and the second sub-memory 124 is larger than the difference in the read speed between the first sub-memory 122 and the second sub-memory 124.

When a reference failure occurs in the upper memory layer 110, the data for which the reference failure has occurred is loaded from the first sub-memory 122 or the second sub-memory 124 in the intermediate memory layer 120. If the corresponding data does not exist even in the intermediate memory layer 120, the data for which the reference failure has occurred is loaded from the storage device layer 130.

The storage device layer 130 stores all the data for execution of a program. The storage device layer 130 consists of a nonvolatile memory, and a flash memory or a hard disk drive.

In response to a request from the CPU 200, the storage device layer 130 provides the requested data to the CPU 200 through the intermediate memory layer 120 and the upper memory layer 110.

When the data is initially loaded, the second sub-memory 124 may load the data from the storage device layer 130 to provide the data to the upper memory layer 110. In this way, in an illustrative embodiment of the present inventive concept, the data to be initially provided from the storage device layer 130 to the upper memory layer 110 consists of a volatile memory which is first provided to the upper memory layer 110 through the second sub-memory 124 consisting of a volatile memory. Thereafter, when a memory reference failure occurs in the upper memory layer 110, the upper memory layer 110 requests the corresponding data from both the first sub-memory 122 and the second sub-memory 124 to receive the corresponding data from the first sub-memory 122 and the second sub-memory 124.

The memory management unit 140 is connected to the cache memory layer 110, the intermediate memory layer 120 or the storage device layer 130 to control whether to transfer data stored in each of the memory layers. Especially, in an illustrative embodiment of the present inventive concept, among data stored in the second sub-memory 124, data with a low probability to be referenced again is transferred in advance to the first sub-memory 122. Due to this operation, it can turn off the second sub-memory 124 according to a specific condition, time and efforts required to transfer the data stored in the second sub-memory 124 to the first sub-memory 122 can be reduced.

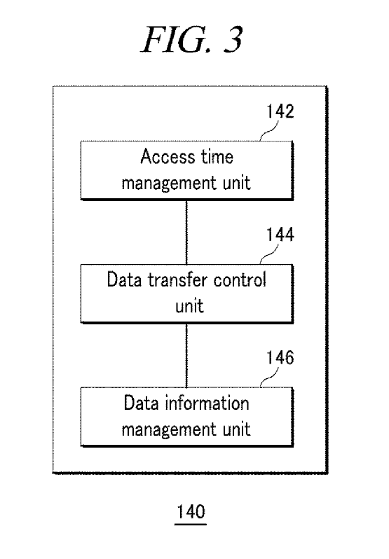

FIG. 3 illustrates a detailed configuration of a memory management unit in accordance with an illustrative embodiment of the present inventive concept.

The memory management unit 140 may include an access time management unit 142, a data transfer control unit 144 and a data information management unit 146.

Prior to describing each of the components, various types of data managed by the memory management unit 140 will be described. Data stored in the second sub-memory 124 may be classified into dirty data and clean data. In general, when new data is written in a cache memory through a CPU, the same data is also written in the main memory (RAM), in addition to the cache memory, such that the data in both memories are consistent with each other. However, those operations are classified into a write through method and a write back method depending on whether the data are recorded into the memories at the same time. The write through method writes data in the cache memory and the RAM at the same time, whereas the write back method writes data only in the cache memory at first and records the data into the RAM later when the data is replaced and evicted from the cache memory. Therefore, with the write through method, the record operation needs to be performed each time for the main memory which exhibits a lower speed than the cache memory. Accordingly, in order to overcome the slowing down of the whole operation speed, the write back method is usually adopted. However, with the write back method, it is necessary to check the state of the main memory and determine whether the data of the main memory is consistent with that of the cache memory or whether any update for data consistency with the cache memory is required to be performed later.

If the data stored in the cache memory and the data stored in the main memory are identical to each other, the data in the cache memory is referred to as data in the clean state (hereinafter, “clean data”). If the data of the cache memory has been modified but the data in the main memory has not been updated yet, the data in the cache memory is referred to as data in the dirty state (hereinafter, “dirty data”). Usually, the dirty or clean state of data is indicated by means of flags, dirty bits or others. That is, in the relation between the cache memory which is an upper memory and the RAM which is a lower memory, dirty bits are used to indicate whether or not a value stored in the cache memory has been changed from that in the main memory. As a data block of the cache memory where the dirty bit is set has a different value from that of a data block of the main memory, the data of the cache memory block will be recorded in the main memory later when being replaced.

When data stored in the second sub-memory 124 are needed to be transferred to the first sub-memory 122 for turning off the second sub-memory 124, since storing operations are needed for dirty data to transferring the data in the second sub-memory to a non-volatile memory such as the first sub-memory 122, a significant amount of time may be consumed. Accordingly, in the illustrative embodiment of the present inventive concept, among the data stored in the second sub-memory 124, data with low probability of occurrence of a re-access event are transferred in advance to the first sub-memory 122.

To this end, the access time management unit 142 manages information when an access is occurred to the data stored in the first sub-memory 122 or the second sub-memory 124. Thereafter, whether to transfer data is determined based on the access time information for each of the data.

The data transfer control unit 144 deter nines data with a low probability of occurrence of a re-access event so that the data can be transferred to the first sub-memory 122. The re-access event may include both a read event and a write event with respect to a memory.

The data information management unit 146 manages various states, address information, and address conversion information for data transfer, etc. of the data stored in the first sub-memory 122 or the second sub-memory 124 so that when a request for access by the upper memory layer 110 to the intermediate layer 120 or the storage device layer 130 is made, data corresponding to the request can be transmitted to the upper memory layer 110.

Now, transferring methods are described in detail with reference to the drawings.

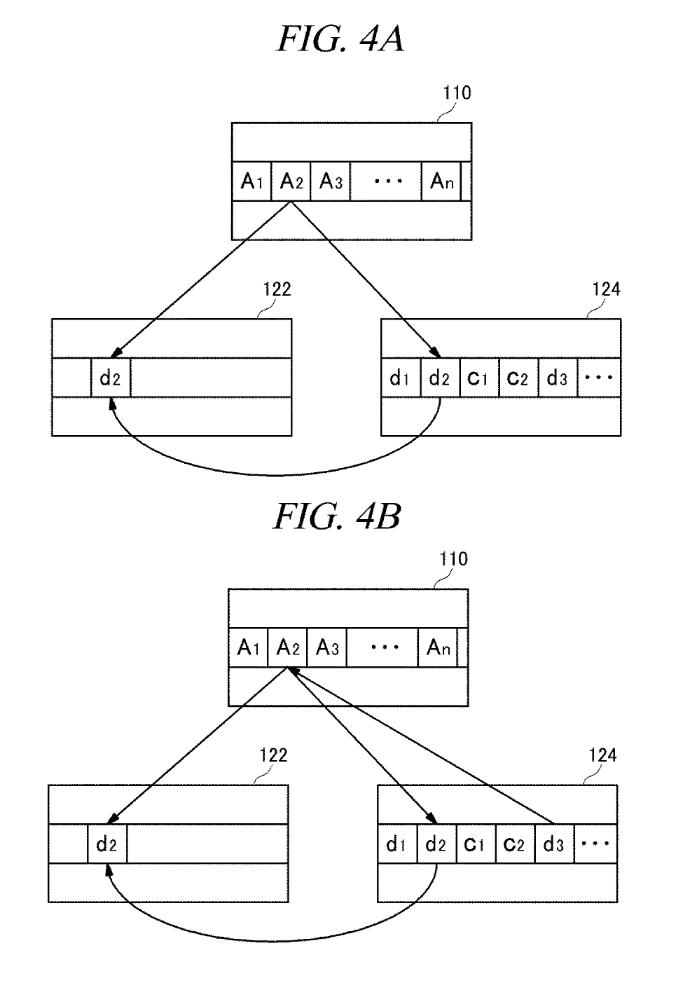

FIG. 4A and FIG. 4B depict a data transferring method by the memory management unit in accordance with an illustrative embodiment of the present inventive concept.

Referring to FIG. 4A, the memory management unit 140 periodically checks the time elapsed since the dirty data fell in the dirty state. If the time elapsed after becoming dirty data exceeds a pre-set threshold, the memory management unit 140 lets the corresponding data d2 to be transferred to the first sub-memory 122. That is, if there hasn't been any access to the dirty data for a specific time, the memory management unit 140 determines that the possibility for the additional access to the data is very low in the future, and transfers the data to the first sub-memory 122.

Further, referring to FIG. 4B, when a data replacement event for the dirty data occurs, if the time elapsed after the corresponding dirty data fell in the dirty state and before the replacement event occurs exceeds a pre-set threshold, the memory management unit 140 lets the corresponding data to be transferred to the first sub-memory 122. For example, assuming that there is data d2 of the second sub-memory 124 in association with data A2 of the upper memory layer 110, there may be the case where the data A2 of the upper memory layer 110 is replaced by other data d3 of the second sub-memory 124. In this case, the data d2 may be updated based on the data A2. And, if the data has been in the dirty state while any replacement event hasn't occurred yet for a significant amount of time, the memory management unit 140 determines that no access to the corresponding data will occur in the future either, and transfers the corresponding data to the first sub-memory 122.

Since the above-described method periodically checks the elapsed time after becoming dirty data and periodically executes the necessary processes, which may not be suitable for optimization. Therefore, the elapsed time may be compared with a threshold only when a data replacement event occurs for the cache memory set storing the dirty data.

While the above-described illustrative embodiment of the present inventive concept describes a method for transferring dirty data, the dirty data or clean data may be selected and transferred according to a general cache block replacement policy.

Thus, when the time elapsed after the dirty data stored in the second sub-memory 124 fell in the dirty state is shorter than a threshold, or the number of the dirty data stored in the second sub-memory 124 is smaller than a pre-set threshold, the memory management unit 140 may select one of the clean data to transfer it to the first sub-memory 122. If there are a multiple number of clean data, the memory management unit 140 may transfer the clean data which has been least recently accessed by the upper memory layer 110 among those from the multiple clean data.

Further, when the data which has been most recently accessed by the upper memory layer 110 among the data stored in the second sub-memory 124 is dirty data, the memory management unit 140 may transfer clean data stored in the second sub-memory 124 to the first sub-memory 122.

Meanwhile, in the illustrative embodiment of the present inventive concept, the memory management unit 140 may package data to be transferred to the first sub-memory 122 and transfer the packaged data at once.

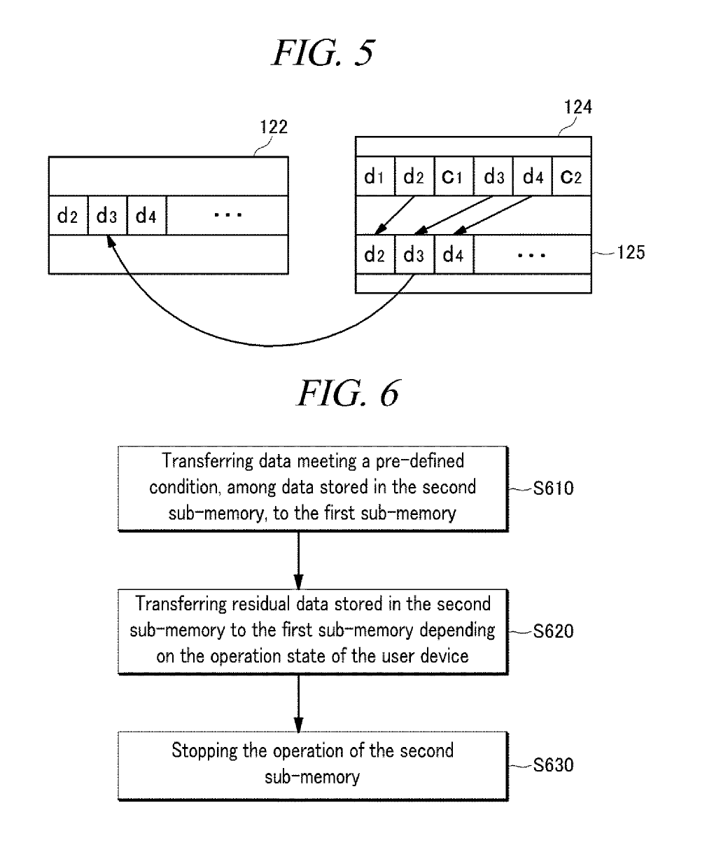

FIG. 5 depicts a data transferring method by the memory management unit in accordance with an illustrative embodiment of the present inventive concept.

As illustrated, the memory management unit 140 stores data determined to be transferred in a pre-set area 125 of the second sub-memory 124, and transfers the corresponding data to the first sub-memory 122 when the number of the data stored in the pre-set area 125 exceeds a threshold. In addition to the dirty data, the clean data may also be stored in the pre-set area 125.

Meanwhile, the memory management unit 140 may perform the memory management in a different manner when it is operated using the write through method. That is, since the write through method has no concepts of the dirty data and the clean data, the memory management unit 140 may use the time elapsed after the latest reference to the data stored in the upper memory layer 110 that has occurred to determine which space of the first sub-memory 122 and the second sub-memory 124 is to store the data.

The memory management unit 140 periodically checks the time elapsed after the latest reference occurred to the data stored in the upper memory layer 110. Then, when the time exceeds a threshold, the memory management unit 140 may transfer the data stored in the second sub-memory 124 in association with the corresponding data to the first sub-memory 122. That is, the memory management unit 140 keep the most recently referenced time of the data, as the possibility of that data to be accessed again in the near future is lower, and thus lets the data to be stored in the first sub-memory 122.

FIG. 6 is a flow diagram illustrating a memory management method in accordance with an illustrative embodiment of the present inventive concept.

First, the memory management unit 140 transfers the data corresponding to a pre-set condition, among the data stored in the second sub-memory 124, to the first sub-memory 122 (S610).

For example, as depicted through FIG. 4A and FIG. 4B, when the time elapsed after the dirty data fell in the dirty state exceeds a threshold, the memory management unit 140 transfers the corresponding data to the first sub-memory 122. In addition, when the time elapsed before a data replacement event occurred since the dirty data had fallen in the dirty state exceeds as threshold, the memory management unit 140 determines that a re-access event for the corresponding dirty data is unlikely to occur, and transfers the corresponding dirty data to the first sub-memory 122.

In addition, the memory management unit 140 may transfer clean data, rather than dirty data in some occasions. That is, when the time elapsed after the dirty data fell into the dirty state is smaller than a threshold, the number of dirty data is not significant, or it was the dirty data which the latest access was made to, the memory management unit 140 may select the clean data and transfer them to the first sub-memory 122.

Next, the memory management unit 140 transfers the rest of the data stored in the second sub-memory 124 to the first sub-memory 122 depending on the operation state of the user device. For example, when the user device enters into an idle mode in accordance with an operation condition of the user device or the user's request, the memory management unit 140 transfers all of the rest data stored in the second sub-memory 124 to the first sub-memory 122. The rest data may include dirty data or clean data.

This is intended to transfer data stored in the second sub-memory 124 to the first sub-memory 122 prior to turn off the second sub-memory 124, thereby preventing occurrence of a cache miss.

In addition to the idle mode, the temperature of the user device may be sensed, and the transferring operation may be performed accordingly. For example, with a temperature sensor provided in the user device, when the temperature sensed by the temperature sensor exceeds a threshold, the second sub-memory 124 is turned off so that the heat generation of the memory system 100 is reduced. The temperature sensor may be included in any location inside the user device, and may be included in the inside of the memory system 100 in some cases.

Next, when the transfer of the data stored in the second sub-memory 124 is completed, the memory management unit 140 turns off the second sub-memory 124 (S630). In this way, the driving of the second sub-memory 124 may be selectively stopped based on the operation state of the user device. In the case that the second sub-memory 124 consists of DRAM, etc., a periodic refresh operation for storage of data is necessary. Therefore, if the driving can be temporarily stopped based on the operation state as in the illustrative embodiment of the present inventive concept, it is possible to reduce power consumed by the refresh operation, and it is also possible to resolve the problem of excessive heat emission resulting from the refresh operation. Furthermore, by stopping the operation of the second sub-memory 124 and using the first sub-memory 122 with relatively low read and write performances, the illustrative embodiment of the present inventive concept can increase memory reference delay thereby decreasing the operation performance of the CPU, etc., so that consumption of power used by the CPU can be reduced and therefore the heat generation problem can be resolved.

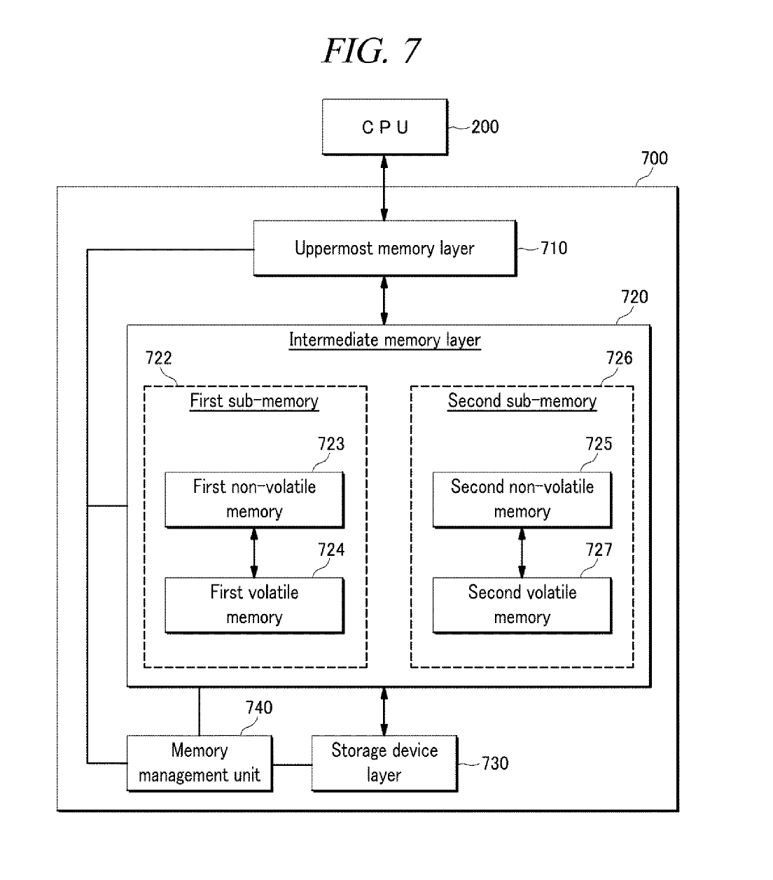

FIG. 7 illustrates a memory system in accordance with another illustrative embodiment of the present inventive concept.

A memory system 700 includes an upper memory layer 710, an intermediate memory layer 720, a storage device layer 730 and a memory management unit 740.

Upon comparison with the embodiment of FIG. 2, the configuration of the intermediate memory layer 720 is somewhat different form that of FIG. 2. For example, the upper memory layer 710 corresponds to a L1 cache; a nonvolatile memory 723 and a first volatile memory 725 of the first sub-memory 722 and the second sub-memory 726 correspond to L2/L3 caches. Like this, part of the cache memory may also include a nonvolatile memory and a volatile memory, which are different in characteristics, in a parallel structure.

The configuration of each of the sub-memories may be similar to the configuration of the intermediate memory layer 120 of FIG. 2. That is, the first sub-memory 722 may use at least one memory of MRAM, PRAM and FRAM as the first nonvolatile memory 723 or the second nonvolatile memory 724.

To the contrary, the second sub-memory 726 includes SRAM or DRAM with faster read/write speed performances than the first sub-memory 722.

Like this, the above-described configuration where the first sub-memory 722 and the second sub-memory 726 are provided and data stored in the second sub-memory 726 meeting a pre-set condition are transferred to the first sub-memory 722 can be applied to the cache memory as well.

That is, as depicted through FIG. 3 to FIG. 6, the memory management unit 740 can perform transferring dirty data meeting a pre-set condition among the dirty data of the second sub-memory 726 or clean data to the first sub-memory 722. As such, the memory management unit 740 can selectively turn off second sub-memory 726 according to the operation state of the user device. As a result, in the illustrative embodiment of the present inventive concept, when the second sub-memory 726 consists of a memory requiring a periodic refresh operation, the second sub-memory 726 is temporarily turned off according to the operation state, so that power consumed by the refresh operation, etc., can be reduced. In addition, in another illustrative embodiment of the present inventive concept, the heat generation problem resulting from the refresh operation can be resolved.

The methods and the systems of the present inventive concept have been described in relation to the certain examples. However, the components or parts or all the operations of the method and the system may be embodied using a computer system having universally used hardware architecture.

The above description of the illustrative embodiments of the present inventive concept is provided for the purpose of illustration, and it would be understood by those skilled in the art that various changes and modifications may be made without changing technical conception and essential features of the illustrative embodiments of the present inventive concept. Thus, it is clear that the above-described illustrative embodiments of the present inventive concept are illustrative in all aspects and do not limit the present disclosure. For example, each component described to be of a single type can be implemented in a distributed manner. Similarly, components described to be distributed can be implemented in a combined manner.

The scope of the inventive concept is defined by the following claims and their equivalents rather than by the detailed description of the illustrative embodiments of the present inventive concept. It shall be understood that all modifications and embodiments conceived from the meaning and scope of the claims and their equivalents are included in the scope of the inventive concept.

### EXPLANATION OF CODES

| | |
|---|---|
| 100: memory system | 110: upper memory layer |
| 120: intermediate memory layer | 122: first sub-memory |
| 124: second sub-memory | 130: storage device layer |
| 140: memory management unit | |

1. A memory system having multiple memory layers, the memory system comprising of:
an upper memory layer;
an intermediate memory layer comprising a first sub-memory consisting of a nonvolatile memory and a second sub-memory consisting of a volatile memory in a parallel structure is positioned below the upper memory layer; and
a memory management unit to control operations of the upper memory layer, and the intermediate memory layer,
wherein the intermediate memory layer is referred by the upper memory layer, and
the memory management unit stores data meeting a predetermined condition among data stored in the second sub-memory into the first sub-memory in advance when a user device comprising the memory system is operating in a normal mode.

2. The memory system of claim 1,
wherein the first sub-memory comprises a first nonvolatile memory operating as a cache memory and a second nonvolatile memory operating as a main memory, and
the second sub-memory comprises a first volatile memory operating as a cache memory and a second volatile memory operating as a main memory.

3. The memory system of claim 1,
wherein the memory management unit periodically checks time elapsed since dirty data fell into the dirty state, and when the value exceeds a pre-set threshold, the memory management unit stores the dirty data into the first sub-memory.

4. The memory system of claim 1,
wherein when a data replacement event occurs in the second sub-memory, the memory management unit stores dirty data preferentially into the first sub-memory.

5. The memory system of claim 1,
wherein when a data replacement event for dirty data occurs, if time elapsed since the dirty data fell into the dirty data and before the data replacement event occurs exceeds a pre-set threshold, the memory management unit stores the dirty data in the first sub-memory.

6. The memory system of claim 1,
wherein when time elapsed since dirty data among the data fell into the dirty state is smaller than a first threshold, or the number of dirty data stored in the second sub-memory is smaller than a second threshold, the memory management unit stores clean data stored in the second sub-memory into the first sub-memory.

7. The memory system of claim 1,
wherein when among the data, data that has been most recently accessed by the upper memory layer is dirty data, the memory management unit stores clean data stored in the second sub-memory into the first sub-memory.

8. The memory system of claim 1,
wherein the memory management unit stores data meeting a predetermined condition among the data stored in the second sub-memory into a pre-set area of the second sub-memory, and when the number of the data stored in the pre-set area exceeds a threshold, the memory management unit stores the data into the first sub-memory.

9. The memory system of claim 1,
wherein when the user device enters into an idle mode, the memory management unit stores the rest data stored in the second sub-memory into the first sub-memory, and then, stops driving the second sub-memory.

10. The memory system of claim 1,
wherein when a temperature of the user device exceeds a threshold, the memory management unit stores the rest data stored in the second sub-memory into the first sub-memory, and then, stops driving the second sub-memory.

11. The memory system of claim 1,
wherein the first sub-memory consists of at least one of MRAM, PRAM and FRAM.

12. A memory system having multiple memory layers, the memory system comprising of:
an upper memory layer;
an intermediate memory layer comprising a first sub-memory consisting of a nonvolatile memory and a second sub-memory consisting of a volatile memory in a parallel structure is positioned below the upper memory layer; and
a memory management unit that transfers data stored in the second sub-memory into the first sub-memory based on time elapsed since the latest reference to the data stored in the upper memory layer,
wherein when the time elapsed since the latest reference exceeds a threshold, the memory management unit transfers the data to the first sub-memory.

13. The memory system of claim 12,
wherein when a user device comprising the memory system enters into an idle mode, the memory management unit stores the rest data stored in the second sub-memory into the first sub-memory, and then, stops driving the second sub-memory.

14. The memory system of claim 12,
wherein when a temperature of the user device exceeds a threshold, the memory management unit stores the rest data stored in the second sub-memory into the first sub-memory, and then, stops driving the second sub-memory.

15. A memory management method of a memory system, which comprises an upper memory layer and an intermediate memory layer, and in which the intermediate memory layer is positioned below the upper memory layer and comprises a first sub-memory consisting of a nonvolatile memory and a second sub-memory consisting of a volatile memory, the memory management method comprising:
(a) storing data which meets a pre-set condition among data stored in the second sub-memory into the first sub-memory;
(b) storing the rest data stored in the second sub-memory into the first sub-memory depending on the operation state of a user device comprising the memory system; and
(c) stopping driving the second sub-memory when storing the rest data is completed.

16. The memory management method of claim 15,
wherein the step (a) comprises:
periodically checking time elapsed since dirty data stored in the second sub-memory fell into the dirty state; and
storing the dirty data into the first sub-memory when the elapsed time exceeds a pre-set threshold.

17. The memory management method of claim 15,
wherein in the step (a), when a data replacement event having dirty data as a replacement candidate block occurs, if time elapsed since the dirty data fell into the dirty state and until the data replacement event occurs exceeds a pre-set threshold, the dirty data are stored in the first sub-memory.

18. The memory management method of claim 15,
wherein the step (a) comprises:
a step of storing dirty data meeting the pre-set condition into a pre-set area of the second sub-memory; and
a step of storing the dirty data stored in the pre-set area into the first sub-memory when the number of the dirty data stored in the pre-set area exceeds a threshold or the user device enters into an idle mode.

19. The memory management method of claim 15,
wherein the step (b) stores the rest data stored in the second sub-memory into the first sub-memory when the user device enters into an idle mode.

20. The memory management method of claim 15,
wherein the step (b) comprises:
sensing a temperature of the user device; and
storing the rest data stored in the second sub-memory into the first sub-memory when the temperature of the user device exceeds a threshold.
